(19) United States
(12) Patent Application Publication
(10) Pub. No.: US 2005/0123663 A1
(43) Pub. Date: Jun. 9, 2005

(54) Shredded food products and methods of producing and applying shredded food products

(76) Inventors: Robert David White, Castle Rock, CO (US); Ashok Shashikant Dhruv, Englewood, CO (US); Timothy G. Prins, Highlands Ranch, CO (US); David Lee Belville, Chagrin Falls, OH (US); William D'Amico, North Ridgeville, OH (US); Kevin T. Kermode, Bainbridge, OH (US); Russell C. Bombik, Mayfield Heights, OH (US)

Correspondence Address: JOHN S. PRATT, ESQ;KILPATRICK STOCKTON, LLP, 1100 PEACHTREE STREET, ATLANTA, GA, 30309, US

(21) Appl. No.: 10/970,022

(22) Filed: Oct. 21, 2004

Related U.S. Application Data
(60) Provisional application No. 60/513,145, filed on Oct. 21, 2003.

(51) Int. Cl. A01J 1/00

(52) U.S. Cl. 426/518

(57) ABSTRACT

Methods for producing fragments of a food product are disclosed. The method includes providing an amount of a formable food product, dividing a single input flow of the formable food product into multiple output streams, extruding the formable food product through an orifice to form strands and cutting the strands of formable food product into pieces. The method may be used be used to produce fragments of cheese that have an appearance similar to cheese that has been shredded. A method is also disclosed for applying the fragments of food product to a base food product, such as a sandwich or pizza.

### CROSS-REFERENCE TO RELATED APPLICATIONS

This application claims priority to U.S. application Ser. No. 60/513,145, filed on Oct. 21, 2003.

### BACKGROUND

1. Field of the Invention

The invention relates generally to shredded formable food products and methods of producing and applying to another food product. More specifically, the invention relates to shredded cheeses and method of producing shredded cheeses for application to a food product.

2. General Background of the Invention

A common method of making a food product involves applying fragments of topping to the surface of the food product. For example, cheese shreds may be deposited on the surface of a pizza or icing fragments may be deposited on the surface of a pastry. Toppings provide additional flavor and also add dimensionality to the appearance of the food product.

It is known in the food industry to deposit pre-made or on-line shredded cheese as a topping on a variety of products, such as pizza, hand-held sandwiches, snack items and the like. Many processes involve simply applying a traditional cheese that has been shredded. Such cheeses, however, suffer from many deficiencies. The cheese by its very nature may be inconsistent in its viscosity, dispersement of fats or other ingredients, or size. Thus, a cheese that is more homogeneous in the dispersal of its ingredients and in size is needed.

Depositing of cheese is generally done with a raking carousel or a vibratory belt or other conveyer. These methods are limited in that the variability of depositing the shredded cheese is high, from around 5% to as much as 25%. Additionally, these methods create large amounts of wasted cheese that is either discarded or additional resources must be used to recycle the cheese. What is needed is a method for depositing cheese on a food product that is continuously and evenly distributed and reduces waste.

### BRIEF SUMMARY

Certain embodiments of the invention provide a method for producing fragments of a food product. The method includes providing an amount of a formable food product, dividing a single input flow of the formable food product into multiple output streams, extruding the formable food product through an orifice to form strands and cutting the strands of formable food product into pieces.

Other embodiments of the invention provide a method for producing producing a shredded cheese product. The method includes providing an amount of a cheese product, dividing a single input flow of the cheese product into multiple output streams, extruding the cheese product through orifices to form strands and cutting the strands of cheese product into pieces.

Certain embodiments of the invention provide a method of applying a shredded cheese product on a dough product. The method includes providing an amount of a cheese product, working the cheese product to render it flowable, dividing a single input flow of the cheese product into multiple output streams, extruding the cheese product through orifices into strands, cutting the strands into pieces, depositing the pieces of cheese product onto a dough product and compressing the pieces of cheese product into the dough product.

Other embodiments of the invention provide a shredded cheese product produced by a method including providing an amount of a cheese product, dividing a single input flow of the cheese product into multiple output streams, extruding the cheese product through orifices to form strands and cutting the strands of cheese product into pieces.

### BRIEF DESCRIPTION OF THE DRAWINGS

FIG. 1 is a diagram of a process for forming shredded cheese according to certain embodiments of the invention.

FIG. 2 is a diagram of a process for impregnating a shredded cheese according to certain embodiments of the invention into a dough product.

FIG. 3A is an end view of a manifold of a pipe nozzle according to certain embodiments of the invention.

FIG. 3B is an end view of cross-section of a die plate of a pipe nozzle according to certain embodiments of the invention.

FIG. 3C is an end view sectional view of flow adjustment bar of a pipe nozzle according to certain embodiments of the invention.

FIG. 3D is an end view of a screw-in plug of a pipe nozzle according to certain embodiments of the invention.

FIG. 4 is a side sectional view of a cutting mechanism and pipe nozzle according to certain embodiments of the invention.

FIG. 5A is a bottom plan view of a manifold of a pipe nozzle according to certain embodiments of the invention.

FIG. 5B is a bottom plan view of a die plate of a pipe nozzle according to certain embodiments of the invention.

FIG. 5C is a bottom plan view of a flow adjustment bar of a pipe nozzle according to certain embodiments of the invention.

FIG. 5D is a bottom plan view of screw-in plugs of a pipe nozzle according to certain embodiments of the invention.

### DETAILED DESCRIPTION

Embodiments of the invention will now be described more fully with reference to the drawings.

Certain embodiments of the invention are directed to a method for producing a shredded food product. A continuous process forms a formable food product into a shredded food product. As used herein, formable food product refers to any food product that is capable of being extruded or otherwise formed into a particular shape. Examples of a formable product include, but are not limited to, cheese, butter, margarine, peanut butter, chocolate, meat, dough and pretzels.

Other embodiments of the invention produce a shredded cheese product. The starting cheese product may be in any starting form, such as block form, cubed, chunked, shredded, torn or chopped. The starting cheese product may be any type of cheese. Mozzarella or provarella (a mozzarella and provolone blend) have been found to be good starting cheese products. Additional cheeses, such as ramona, parmesan, etc. may be added for flavor.

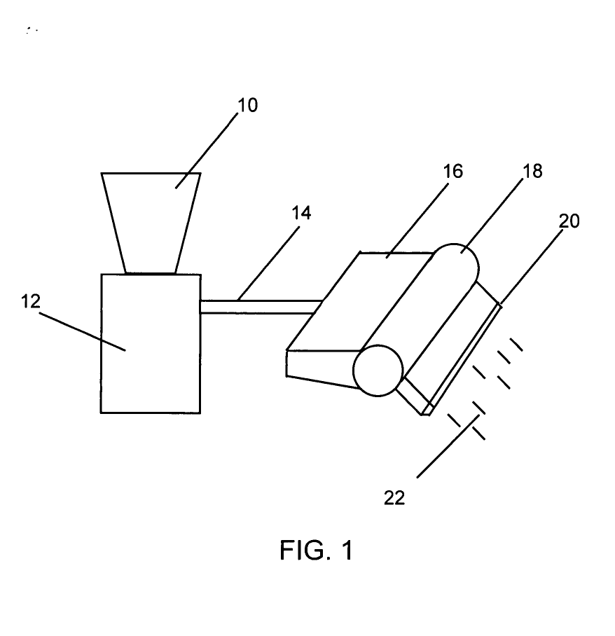

A continuous process for producing a shredded food product is shown in FIG. 1. If a solid formable food product is used as the starting product, the formable food product is comminuted to a size sufficient to fit in a hopper 10 attached to a pump 12. The formable food product may be compressed and otherwise worked through a pump 12 until it is “flowable.” As used herein, flowable generally refers to a semi-solid or liquid state in which the product moves or runs smoothly with substantially unbroken continuity, as in the manner characteristic of a fluid. The pump 12 converts blocked, cubed, diced or shredded forms of a solid starting food product into a flowable form, which can be pumped under pressure. The pump 12 may be any pump 12 that can accurately dose and apply a formable food product in conjunction with a die plate. For example, the pump 12 may be any one of the following types: a conventional positive displacement pump, a progressively reducing cavity type, such as from vendor Moyno, other single or twin screw extruder, such as from vendors Clextral Group, Reiser or Vemag Maschinenbau, or a vane pump, such as from vendors Risco or Reiser. A positive displacement double screw vacuum pump with a tote dumper and an auger in the hopper has been found to be particularly useful for practicing the invention.

In some embodiments, the formable food product is pumped through pipe 14 to a dividing manifold 16, which is preferably in communication with a series of dies or a die plate 20. The dividing manifold 16 provides a mechanism to precisely divide a single input flow of the pipe 14 from the pump exit into multiple output streams of equal flow for further processing. The division of a single input flow into multiple output streams is herein referred to as “flow-dividing.” In some embodiments, the flow of the formable food product may expand from the pipe 14 exiting the pump 12, which may be approximately three to four inches, to the multiple output streams of the dividing manifold 16, which may be approximately four to fifty inches.

The formable food product flows from the dividing manifold 16 to a water wheel 18, such as that manufactured by Reiser. The water wheel 18 operates using a series of vertical vane pumps in a cylindrical housing. The vane pumps are directly connected by metal shafts which ensure that each vane pump rotates at the same rate and delivers the same amount of material. Any one of the above-mentioned pumps 12 may be used to fill the cavities of each vane pump full and distribute the formable food product across the length of a die plate 20.

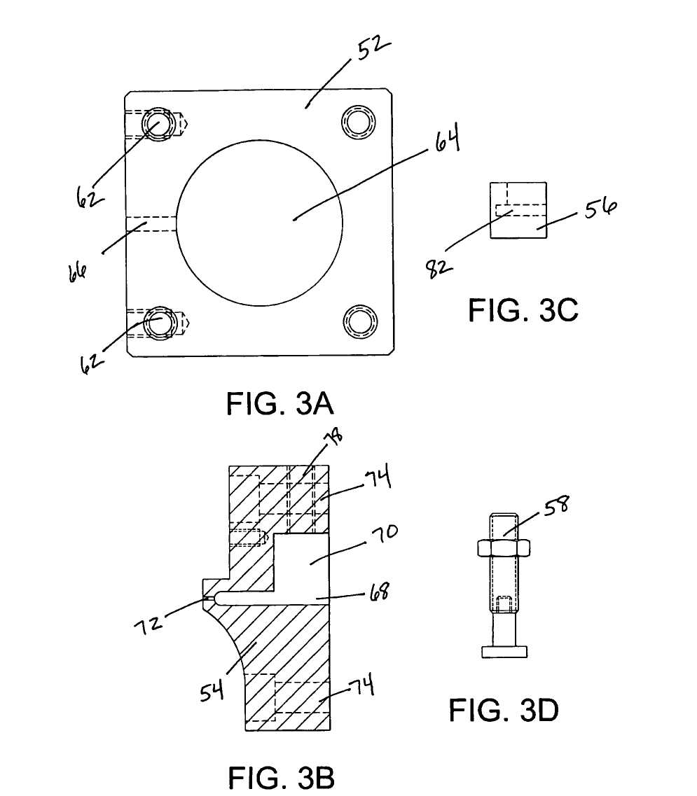

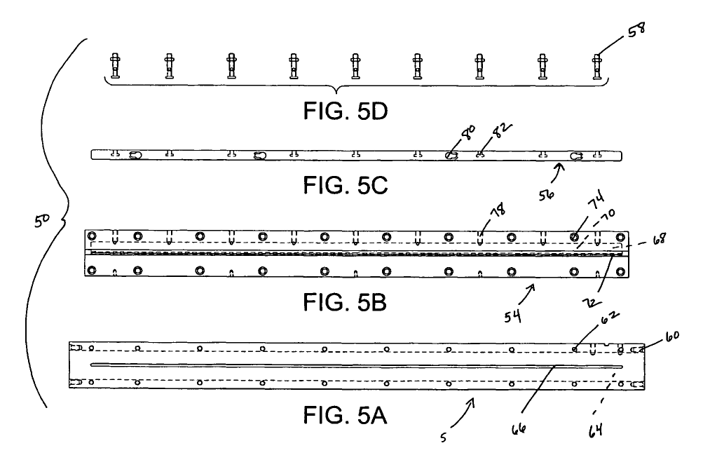

In other embodiments, flow dividing takes place with a unique pipe nozzle 50, as shown in FIGS. 3, 4 and 5A-D. The pipe nozzle 50 may include a generally tubular stainless steel manifold 52 with sanitary fittings 60 on each end. In preferred embodiments, the manifold 52 is square, but has a generally cylindrical input opening 64. The input opening 64 is in communication with an output opening 66. A number of holes 62 may be located along the length of manifold 52 to attach a die plate 54.

The pipe nozzle 50 preferably includes a separate die plate 54 to allow the diameter and number of extrusion holes to be easily changed. The output opening 66 of the manifold 52 is in communication with an input opening 68 in the die plate 54. The die plate 54 may be attached to the manifold 52 by any conventional method, such as rivets, screws, bolts, etc. In some embodiments, the die plate 54 includes holes 74 which receive screws (not shown) that attach the die plate 54 to holes 62 along the length of manifold 52. The input opening 68 in the die plate 54 may include an area 70 for receiving a flow adjustment bar, discussed further below. The die plate includes holes or dies 72 through which the formable food product is extruded.

A flow adjustment bar 56 may be used to control the flow characteristics across the length of the die plate 54. The flow adjustment bar 56 may fit within an area 70 within the input opening 68 in the die plate 54. The flow adjustment bar 56 is attached to the die plate 54 by screw-in plugs 58. The screw-in plugs 58 provides a mechanism for moving the flow adjustment bar 56 so that it controls the stream of formable food product leaving the output opening 66 in the manifold 52. Because the input opening 68 is in communication with the extrusion dies 72, the placement of the adjustment bar 56 affects the flow rate of the stream as it moves through the extrusion dies 72.

The pumped formable food product flows through the series of dies on die plate 20 or die plate 54 as continuous and even strands or strings. The dies may be altered to achieve any desired shape, such as oval, elliptical, L-shaped, triangular, etc. In certain embodiments, the dies through which the formable food product is extruded are designed to replicate a cheese shred 22.

In some embodiments, for example, when drier starting food products are used, the strands or strings spontaneously break into smaller pieces. In other embodiments, the strands or strings are cut with a knife or other cutting device, such as an air blow off, a wire knife, a metal guillotine, rotary cutter, knock-off or a flicker wheel. In some embodiments, the cutting device features a reciprocating or circular motion. The motion of the cutting device and exit speed of the formable food product are two factors that regulate the length of the final food product. The cutting device includes a mechanism for cutting the continuously extruded strands to lengths as short as 1 mm but more preferably 3-10 mm. The cutting mechanism may be an air nozzle that provides a non-contact means of cutting the strands. In other embodiments, the cutting mechanism is a blade and holder attached to the pipe nozzle body. The blade can be moved back and forth by an air cylinder.

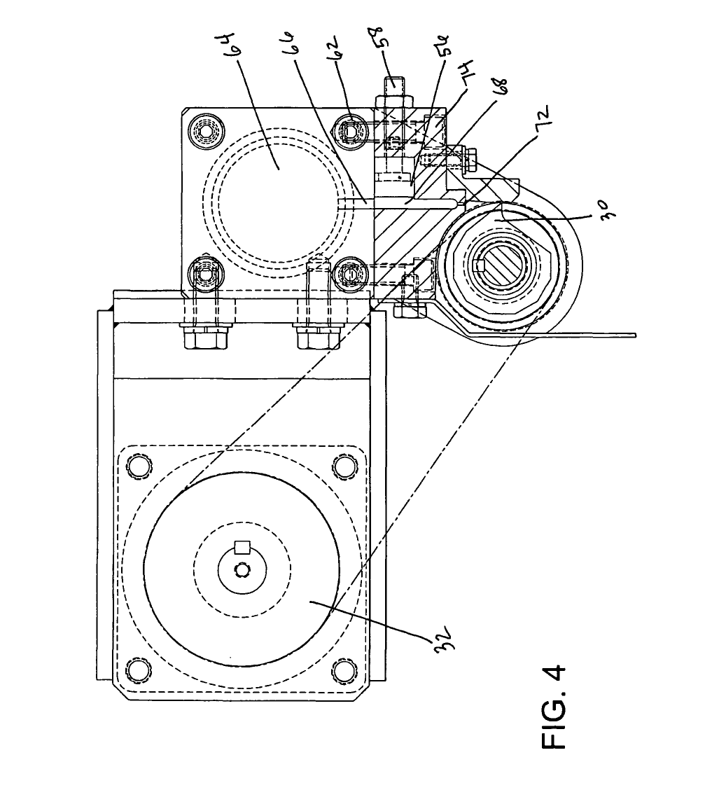

In still other embodiments, shown in FIG. 4, the cutting mechanism uses a rotating blade 30, which shears the strands. The length of the cut strands can be determined by the rotational speed of the precisely controlled driven motor 32 by rotating blade 30. In preferred embodiments, the cutting blade 30 is relocated to more clearance between it and the die plate 54. This aids in keeping the cutting blade 30 from accumulating cheese. Additionally, other methods, such as ultrasonic wave technology may be used to keep the cutting blade clean. The shred size, thickness, and texture characteristics may be adjusted by the die plate, cut-off rate, pump speed and type of cheese.

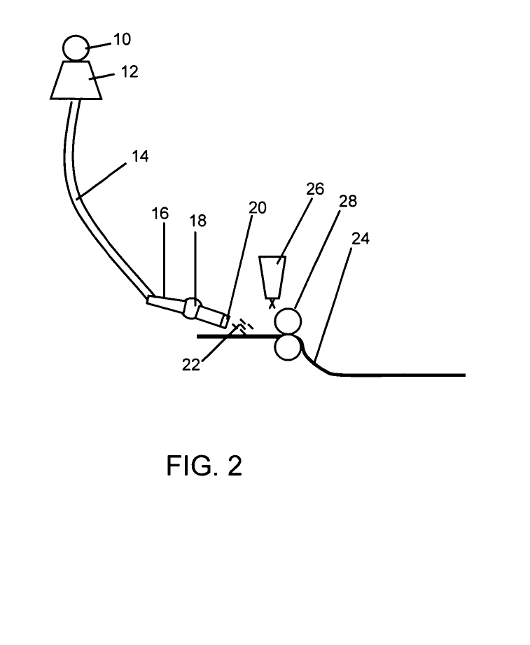

As shown in FIG. 2, the shredded food product 22 may be applied to the surface of a base food product 24 by falling from the die plate 20 by gravity to the top surface of base food product 24, such as a sandwich, pizza or other food item. As used herein, base food product refers to any food product on which the formable food product may be applied to, mixed with, pressed into or otherwise combined with the formable food product.

The distance the shredded food product 22 falls from the die plate 20 to the base food product 24 is preferably from about 2 inches to about 24 inches. The die plate 20 is preferably stationary above the base food product 24 and the base food product 24 travels beneath the die plate 20 at a specified speed. Conversely, the die plate 20 can also move as the base food product 24 moves, or the base food product 24 can remain stationary as the die plate or plates 20 move relative to the base food product 24. Alternatively, multiple die plates 20 may apply the shredded food product 22 with or without motion relative to the base food product 24.

Any or all of the pump 12, manifold 16 and/or die plate 20, among other components, may or may not be jacketed or electrically heat traced for temperature control as an aid to flow and even distribution. Additionally, the components may be cooled as needed to aid in the solidification of a formable food product.

Applying the shredded food product 22 to base food products 24 such as sandwiches and pizzas involves little or no recycling of cheese since generally all of it is used on the top surface of the base food product. However, the shredded food product 22 is also appropriate for applications in which overflow of the shredded food product 22 is expected and is designed to be recycled. Applying the shredded food product 22 in this manner to the top surface of a base food product 24 can be used in pizza processes or any other food product requiring accurate and consistent application of shredded food product 22.

As shown in FIG. 2, in some embodiments, the shredded food product 22 may be impregnated into a base food product 24. After the shredded food product 22 is deposited onto a base food product 24, the shredded cheese product 22 may be compressed into the base food product 24. In some embodiments, the base food product 24 with the shredded food product 22 deposited thereon passes through a two-roll sheeter or reduction roller 28. The pressure from the reduction roller 28 causes the shredded food product 22 to stick to the surface of the base food product 24 and offers a method to adjust the three-dimensional appearance of the shredded food product 22.

The following examples will serve to further illustrate the present invention without, at the same time, however, constituting any limitation thereof. On the contrary, it is to be clearly understood that that resort may be had to various other embodiments, modifications and equivalents thereof which, after reading the description herein, may suggest themselves to those skilled in the art without departing from the spirit and scope of the invention.

### EXAMPLE 1

Production of a Cheese Shred Using a Pipe Nozzle.

The starting material is a 17 lb block of Dairy Source™ cheese. The blocks of cheese are cut into thirds by hand cheese wire. The cheese temperature was 42° F.-47° F. at the time of use and reached a temperature of 59° F. after extrusion.

The pressure in the system is between 350 and 500 psi. The chunked cheese is placed in a Vemag 15C stuffer pump. The Vemag speed is 22.8. to provide approximately 3 grams of cheese on fifteen 2.25 inches by 6.0 inches cheese collection plates on a conveyer. The conveyor speed is 33 feet per minute.

When the cheese exits the pump, it is dispersed to a 34-inch pipe nozzle. The cheese is extruded through a series of holes approximately 1.0 mm in diameter. The holes are specifically designed so that a cross section of the extruded cheese resembles a cheese shred. The cheese is extruded in continuous strands.

A rotating blade is used to cut the cheese from the die plate. The blade rotates at 812 rpm. The length of the cheese shreds is adjusted by changing the rotation rate of the blade. The shredded cheese product is cylindrical and is 1.5-3.0 mm in diameter. The shredded cheese product is 0.5-1.5 inches in length.

### EXAMPLE 2

Production of a Cheese Shred Using Water Wheel.

The starting material is a 17 lb block of Dairy Source™ cheese. The blocks of cheese are cut into thirds by hand cheese wire. The cheese temperature was 42° F.-47° F. at the time of use and reached a temperature of 59° F. after extrusion.

The pressure in the system is between about 350 and 500 psi. The chunked cheese is placed in a Vemag 15C stuffer pump. The Vemag speed is 18 to provide approximately 3 grams of cheese on fifteen 2.25 inches by 6.0 inches cheese collection plates on a conveyer. The conveyor speed is 33 feet per minute.

When the cheese exits the pump, it is initially dispersed to a Reiser 34-inch water wheel via a manifold. The cheese is extruded through a 69-hole die plate or a 102-hole die plate, with holes approximately 1.0 mm in diameter. The holes are specifically designed so that a cross section of the extruded cheese resembles a cheese shred. The cheese is extruded in continuous strands.

A rotating blade is used to cut the cheese from the die plate. The length of the cheese shreds is adjusted by changing the rotation rate of the blade. The shredded cheese product is cylindrical and is 1.5-3.0 mm in diameter. The shredded cheese product is 0.5-1.5 inches in length.

### EXAMPLE 3

Application of a Cheese Shred to a Dough Product.

The cheese shreds from Example 2 are applied to a dough product using reduction rollers. The reduction rollers are dusted with common bread flour to insure that the cheese shreds do not adhere to the surface of the top reduction roller. The cheese shreds first drop onto a sheet of dough. The dough with the cheese shreds on its top surface then is pulled through the reduction rollers. The reduction rollers compress the cheese into the dough. When the resulting dough product is cooked, the cheese shreds provide a pleasing contrast with the dough and add to the three-dimensional appearance of the surface of the dough.

The foregoing description is provided for describing various embodiments and structures relating to the invention. Various modifications, additions and deletions may be made to these embodiments and/or structures without departing from the scope and spirit of the invention.

1. A method for producing fragments of a food product comprising:
(a) providing an amount of a formable food product;
(b) dividing a single input flow of the formable food product into multiple output streams;
(c) extruding the formable food product through an orifice to form strands; and
(d) cutting the strands of formable food product into pieces.

2. The method of claim 1, wherein the formable food product is a naturally produced cheese or processed cheese.

3. The method of claim 1, wherein the formable food product is a semi-solid or solid food product.

4. The method of claim 3, further comprising working the formable food product to render it flowable before dividing it.

5. The method of claim 4, wherein the working comprises pumping the formable food product.

6. The method of claim 1, wherein the formable food product is a liquid.

7. The method of claim 6, further comprising cooling the extruded cheese product to form semi-solid or solid strands.

8. The method of claim 1, further comprising extruding the food product by passing it through a pipe nozzle comprising:
(a) a dividing manifold;
(b) a plate comprising a plurality of dies; and
(c) a plate for adjusting the flow of food product exiting the pipe nozzle.

9. The method of claim 1, further comprising extruding the food product by passing it through a water wheel.

10. The method of claim 1, further comprising cutting the strands of food product with a rotating blade.

11. A method of producing a shredded cheese product comprising:
(a) providing an amount of a cheese product;
(b) dividing a single input flow of the cheese product into multiple output streams;
(c) extruding the cheese product through orifices to form strands; and
(d) cutting the strands of cheese product into pieces.

12. The method of claim 11, wherein the cheese product is a naturally produced cheese.

13. The method of claim 11, wherein the cheese product is a processed cheese.

14. The method of claim 12, further comprising working the cheese product to render it flowable before dividing it.

15. The method of claim 14, wherein the working comprises pumping the cheese product.

16. The method of claim 13, further comprising cooling the extruded cheese product to form semi-solid or solid strands.

17. The method of claim 11, further comprising extruding the cheese product by passing it through a pipe nozzle comprising:
(a) a dividing manifold;
(b) a plate comprising a plurality of dies; and
(c) a plate for adjusting the flow of cheese product exiting the pipe nozzle.

18. The method of claim 11, further comprising extruding the cheese product by passing it through a water wheel.

19. The method of claim 11, further comprising cutting the strands of cheese product with a rotating blade.

20. A method of applying a shredded cheese product on a dough product comprising:
(a) providing an amount of a cheese product;
(b) working the cheese product to render it flowable;
(c) dividing a single input flow of the cheese product into multiple output streams;
(d) extruding the cheese product through orifices into strands;
(e) cutting the strands into pieces;
(f) depositing the pieces of cheese product onto a dough product; and
(g) compressing the pieces of cheese product into the dough product.

21. The method of claim 20, further comprising extruding the cheese product by passing it through a pipe nozzle comprising:
(a) a dividing manifold;
(b) a plate comprising a plurality of dies; and
(c) a plate for adjusting the flow of cheese product exiting the pipe nozzle.

22. The method of claim 20, further comprising extruding the cheese product by passing it through a water wheel.

23. The method of claim 20, further comprising cutting the strands of cheese product with a rotating blade.

24. A shredded cheese product produced by a method comprising:
(a) providing an amount of a cheese product;
(b) dividing a single input flow of the cheese product into multiple output streams;
(c) extruding the cheese product through orifices to form strands; and
(d) cutting the strands of cheese product into pieces.

25. The cheese product of claim 24, wherein extruding the cheese product comprises passing it through a pipe nozzle comprising:
(a) a dividing manifold;
(b) a plate comprising a plurality of dies; and
(c) a plate for adjusting the flow of cheese product exiting the pipe nozzle.

26. The cheese product of claim 24, wherein extruding the cheese product comprises passing it through a water wheel.
